(19) United States
(12) Patent Application Publication
(10) Pub. No.: US 2022/0006167 A1
(43) Pub. Date: Jan. 6, 2022

(54) BASE STATION ANTENNAS AND PHASE SHIFTER ASSEMBLIES ADAPTED FOR MITIGATING INTERNAL PASSIVE INTERMODULATION

(71) Applicant: CommScope Technologies LLC, Hickory, NC (US)

(72) Inventor: Muhammed Ameer P, Kerala (IN)

(21) Appl. No.: 17/291,487

(22) PCT Filed: Feb. 3, 2020
(86) PCT No.: PCT/US2020/016337

§ 371 Date: May 5, 2021

Related U.S. Application Data
(60) Provisional application No. 62/801,813, filed on Feb. 6, 2019.

(51) Int. Cl. H01P 1/18; H01Q 1/24; H01Q 3/32

(52) U.S. Cl. CPC H01P 1/18; H01Q 3/32; H01Q 1/246

(57) ABSTRACT

The present disclosure describes a phase shifter assembly adapted for mitigating internal passive intermodulation within base station antenna. The phase shifter assembly may include a mounting base formed of a non-metallic material; a first main printed circuit board and a second main printed circuit board attached to the mounting base, wherein each of the main printed circuit boards comprises a plurality of radio frequency transmission paths; a first wiper arm rotatably coupled to the first main printed circuit board and electrically coupled to at least some of the plurality of transmission paths; and a second wiper arm rotatably coupled to the second main printed circuit board and electrically coupled to at least some of the plurality of transmission paths on the second primary side of the main printed circuit board. Base station antennas adapted for mitigating internal passive intermodulation are also described.

### STATEMENT OF PRIORITY

The present application claims priority from and the benefit of U.S. Provisional Application Ser. No. 62/801,813, filed Feb. 6, 2019, the disclosure of which is hereby incorporated herein in its entirety.

### FIELD

The present invention relates to communication systems and, in particular, to base station antennas having electronic beam tilt capabilities.

### BACKGROUND

Cellular communications systems are used to provide wireless communications to fixed and mobile subscribers. A cellular communications system may include a plurality of base stations that each provides wireless cellular service for a specified coverage area that is typically referred to as a “cell.” Each base station may include one or more base station antennas that are used to transmit radio frequency (“RF”) signals to, and receive RF signals from, the subscribers that are within the cell served by the base station. Base station antennas are directional devices that can concentrate the RF energy that is transmitted in or received from certain directions. The “gain” of a base station antenna in a given direction is a measure of the ability of the antenna to concentrate the RF energy in that direction. The “radiation pattern” of a base station antenna—which is also referred to as an “antenna beam”—is a compilation of the gain of the antenna across all different directions. Each antenna beam may be designed to service a pre-defined coverage area such as the cell or a portion thereof that is referred to as a “sector.” Each antenna beam may be designed to have minimum gain levels throughout the pre-defined coverage area, and to have much lower gain levels outside of the coverage area to reduce interference between neighboring cells/sectors. Base station antennas typically comprise a linear array of radiating elements such as patch, dipole or crossed dipole radiating elements. Many base station antennas now include multiple linear arrays of radiating elements, each of which generates its own antenna beam.

Early base station antennas generated antenna beams having fixed shapes, meaning that once a base station antenna was installed, its antenna beam(s) could not be changed unless a technician physically reconfigured the antenna. Many modern base station antennas now have antenna beams that can be electronically reconfigured from a remote location. The most common way in which an antenna beam may be reconfigured electronically is to change the pointing direction of the antenna beam (i.e., the direction in which the antenna beam has the highest gain), which is referred to as electronically “steering” the antenna beam. An antenna beam may be steered horizontally in the azimuth plane and/or vertically in the elevation plane. An antenna beam can be electronically steered by transmitting control signals to the antenna that alter the phases of the sub-components of the RF signals that are transmitted and received by the individual radiating elements of the linear array that generates the antenna beam. Most modern base station antennas are configured so that the elevation or “tilt” angle of the antenna beams generated by the antenna can be electronically altered. Such antennas are commonly referred to as remote electronic tilt (“RET”) antennas.

In order to electronically change the down tilt angle of an antenna beam generated by a linear array of radiating elements, a phase taper may be applied across the radiating elements of the array. Such a phase taper may be applied by adjusting the settings on a phase shifter that is positioned along the RF transmission path between a radio and the individual radiating elements of the linear array. One widely-used type of phase shifter is an electromechanical “wiper” phase shifter that includes a main printed circuit board and a “wiper” printed circuit board that may be rotated above the main printed circuit board. Such wiper phase shifters typically divide an input RF signal that is received at the main printed circuit board into a plurality of sub-components, and then couple at least some of these sub-components to the wiper printed circuit board. The sub-components of the RF signal may be coupled from the wiper printed circuit board back to the main printed circuit board along a plurality of arc-shaped traces, where each arc has a different diameter. Each end of each arc-shaped trace may be connected to a respective sub-group of one or more radiating elements. By physically (mechanically) rotating the wiper printed circuit board above the main printed circuit board, the locations where the sub-components of the RF signal couple back to the main printed circuit board may be changed, which thus changes the lengths of the transmission paths from the phase shifter to the respective sub-groups of radiating elements. The changes in these path lengths result in changes in the phases of the respective sub-components of the RF signal, and since the arcs have different radii, the phase changes along the different paths will be different. Typically, the phase taper is applied by applying positive phase shifts of various magnitudes (e.g., +X°, +2X° and)+3X° to some of the sub-components of the RF signal and by applying negative phase shifts of the same magnitudes (e.g., −X°, −2X° and −3X°) to additional of the sub-components of the RF signal. Exemplary phase shifters of this variety are discussed in U.S. Pat. No. 7,907,096 to Timofeev, the disclosure of which is hereby incorporated herein in its entirety. The wiper printed circuit board is typically moved using an electromechanical actuator such as a DC motor that is connected to the wiper printed circuit board via a mechanical linkage. These actuators are often referred to as “RET actuators.” Both individual RET actuators that drive a single mechanical linkage and “multi-RET actuators” that have a plurality of output members that drive a plurality or respective mechanical linkages are commonly used in base station antennas.

### SUMMARY

Embodiments of the present invention are directed to a phase shifter assembly. The phase shifter assembly may comprise a mounting base formed of a non-metallic material; a first main printed circuit board and a second main printed circuit board attached to the mounting base, wherein each of the main printed circuit boards comprises a plurality of radio frequency transmission paths; a first wiper arm rotatably coupled to the first main printed circuit board and electrically coupled to at least some of the plurality of transmission paths; and a second wiper arm rotatably coupled to the second main printed circuit board and electrically coupled to at least some of the plurality of transmission paths on the second primary side of the main printed circuit board.

Embodiments of the present invention are directed to a phase shifter assembly. The phase shifter assembly may comprise a mounting base; a first main printed circuit board and a second main printed circuit board attached to the mounting base, wherein each of the main printed circuit boards comprises a plurality of radio frequency transmission paths; a first wiper arm rotatably coupled to the first main printed circuit board and electrically coupled to at least some of the plurality of transmission paths; a second wiper arm rotatably coupled to the second main printed circuit board and electrically coupled to at least some of the plurality of transmission paths on the second primary side of the main printed circuit board; a plurality of cable clips; and a plurality of mounting standoffs, wherein the plurality of cable clips, the plurality of mounting standoffs and the mounting base form a unitary member formed of a polymeric material.

Embodiments of the present invention are directed to a base station antenna. The base station antenna may comprise a plurality of phase shifter assemblies, each phase shifter assembly may comprise a mounting base formed of a non-metallic material; a first main printed circuit board and a second main printed circuit board attached to the mounting base, wherein each main printed circuit board comprises a plurality of radio frequency transmission paths; a first wiper arm rotatably coupled to the first main printed circuit board and electrically coupled to at least some of the plurality of transmission paths; and a second wiper arm rotatably coupled to the second main printed circuit board and electrically coupled to at least some of the plurality of transmission paths on the second primary side of the main printed circuit board.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1A is a schematic side perspective view of a base station antenna according to embodiments of the present invention.

FIG. 1B is a perspective view of the base station antenna of FIG. 1A with the radome thereof removed.

FIG. 2 is a schematic block diagram illustrating the electrical connections between multiple components of the base station antenna of FIGS. 1A-1B.

FIG. 3A is a top perspective view of a phase shifter assembly.

FIG. 3B is a bottom view of the phase shifter assembly of FIG. 3A.

FIG. 4A is a top perspective view of a phase shifter assembly (without components installed) according to embodiments of the present invention.

FIG. 4B is a bottom perspective view of the phase shifter assembly of FIG. 4A.

FIG. 5A is a top perspective view of the phase shifter assembly of FIG. 4A (with components installed) according to embodiments of the present invention.

FIG. 5B is a bottom view of the phase shifter assembly of FIG. 5A.

FIG. 6A is a top perspective view of the phase shifter assembly of FIG. 5A mounted on an antenna reflector according to embodiments of the present invention.

FIG. 6B is a bottom perspective view of the phase shifter assembly of FIG. 6A.

FIG. 6C is an enlarged side view of a standoff of the phase shifter assembly of FIG. 6A.

FIG. 7A is a top perspective view of the phase shifter assembly of FIG. 5A mounted on an antenna reflector having alternative standoffs according to embodiments of the present invention.

FIG. 7B is a bottom perspective view of the phase shifter assembly shown in FIG. 7A.

FIG. 7C is an enlarged side view of an alternative standoff for the phase shifter assembly of FIG. 7A.

FIGS. 8A-8F illustrates exemplary steps of assembling the phase shifter assembly shown in FIGS. 5A-5B according to embodiments of the present invention.

### DETAILED DESCRIPTION

Pursuant to embodiments of the present invention, base station antennas with new phase shifter assemblies are provided that may reduce internal sources of passive intermodulation (PIM) by eliminating some of the metal-to-metal interfaces within a base station antenna. Embodiments of the present invention will now be discussed in greater detail with reference to the drawings.

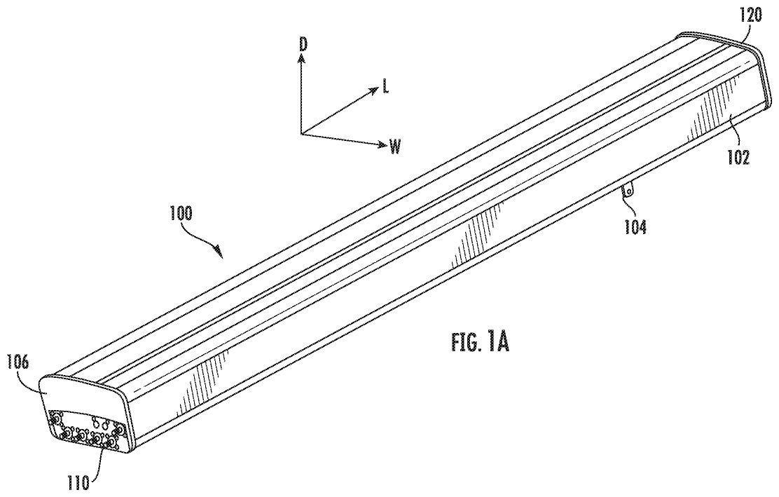

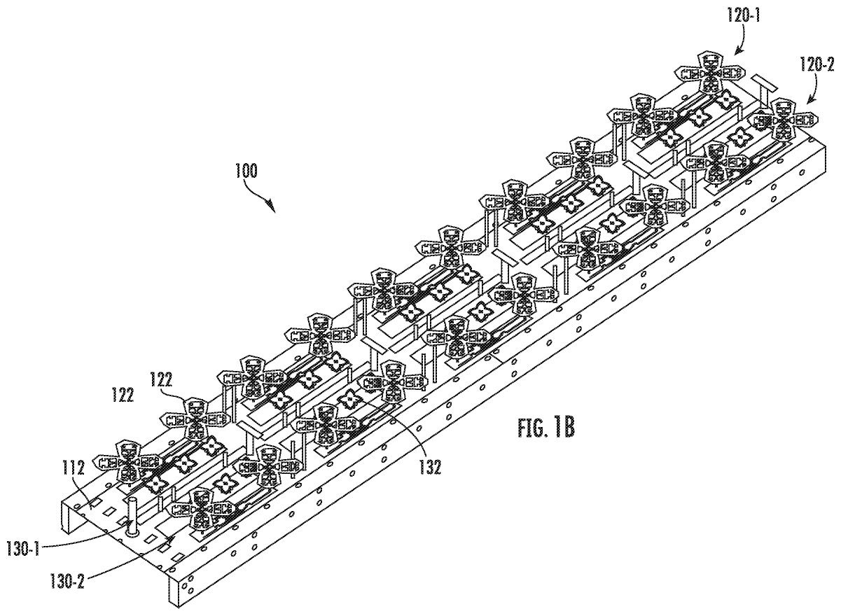

FIG. 1A is a side perspective view of a RET base station antenna 100. As shown in FIG. 1A, the RET base station antenna 100 includes a radome 102, a mounting bracket 104, and a bottom end cap 106. A plurality of input/output ports 110 are mounted in the end cap 106. Coaxial cables (not shown) may be connected between the input/output ports 110 and the RF ports on one or more radios (not shown). These coaxial cables may carry RF signals between the radios and the base station antenna 100. The input/output ports 110 may also include control ports that carry control signals to the base station antenna 100 from a controller that is located remotely from base station antenna 100. These control signals may include control signals for electronically changing the tilt angle of the antenna beams generated by the base station antenna 100. For ease of reference, FIG. 1A includes a coordinate system that defines the length (L), width (W) and depth (D) axes (or directions) of the base station antenna 100 that may be referred to in the application.

FIG. 1B is a side perspective view of the base station antenna 100 with the radome 102 removed to show four linear arrays of radiating elements that may be included in antenna 100. As shown in FIG. 1B, the base station antenna 100 includes two linear arrays 120-1, 120-2 of low-band radiating elements 122 (i.e., radiating elements that transmit and receive signals in a lower frequency band) and two linear arrays 130-1, 130-2 of high-band radiating elements 132 (i.e., radiating elements that transmit and receive signals in a higher frequency band). Each of the low-band radiating elements 122 is implemented as a cross-polarized radiating element that includes a first dipole that is oriented at an angle of −45° with respect to the azimuth plane and a second dipole that is oriented at an angle of +45° with respect to the azimuth plane. Similarly, each of the high-band radiating elements 132 is implemented as a cross-polarized radiating element that includes a first dipole that is oriented at an angle of −45° with respect to the azimuth plane and a second dipole that is oriented at an angle of +45° with respect to the azimuth plane. Since cross-polarized radiating elements are provided, each linear array 120-1, 120-2, 130-1, 130-2, for example, will generate two antenna beams, namely a first antenna beam generated by the −45° dipoles and a second antenna beam generated by the +45° dipoles. The radiating elements 122, 132 extend forwardly from a backplane 112 which may comprise, for example, a sheet of metal that serves as a ground plane for the radiating elements 122, 132.

FIG. 2 is a schematic block diagram illustrating various additional components of the RET base station antenna 100 and the electrical connections therebetween. It should be noted that FIG. 2 does not show the actual location of the various elements on the antenna 100, but instead is drawn to merely show the electrical transmission paths between the various elements.

As shown in FIG. 2, each input/output port 110 may be connected to a phase shifter 150. The base station antenna 100 performs duplexing between transmit and receive sub-bands for each linear array 120, 130 within the antenna (which allows different downtilts to be applied to the transmit and receive sub-bands), and hence each linear array 120, 130 includes both a transmit (input) port 110 and a receive (output) port 110. A first end of each transmit port 110 may be connected to the transmit port of a radio (not shown) such as a remote radio head. The other end of each transmit port 110 is coupled to a transmit phase shifter 150. Likewise, a first end of each receive port 110 may be connected to the receive port of a radio (not shown), and the other end of each receive port 110 is coupled to a receive phase shifter 150. Two transmit ports, two receive ports, two transmit phase shifters and two receive phase shifters are provided for each linear array 120, 130 to handle the two different polarizations.

Each transmit phase shifter 150 divides an RF signal input thereto into five sub-components, and applies a phase taper to these sub-components that sets the tilt (elevation) angle of the antenna beam generated by an associated linear array 120, 130 of radiating elements 122, 132. The five outputs of each transmit phase shifter 150 are coupled to five respective duplexers 140 that pass the sub-components of the RF signal output by the transmit phase shifter 150 to five respective sub-arrays of radiating elements 122, 132. In the example antenna 100 shown in FIGS. 1A, 1B and 2, each low-band linear array 120 includes ten low-band radiating elements 122 that are grouped as five sub-arrays of two radiating elements 122 each. Each high-band linear array 130 includes fifteen high-band radiating elements 132 that are grouped as five sub-arrays of three radiating elements 132 each. Each sub-array is shown in FIG. 2 as a box with an “X” in it, where the “X” may represent two or three individual radiating elements. Each sub-array of radiating elements passes received RF signals to a respective one of the duplexers 140, which in turn route those received RF signals to the respective inputs of an associated receive phase shifter 150. The receive phase shifter 150 applies a phase taper to each received RF signal input thereto that sets the tilt angle for the receive antenna beam and then combines the received RF signals into a composite RF signal. The output of each receive phase shifter 150 is coupled to a respective receive port 110.

While FIGS. 1B and 2 show an antenna having two linear arrays 120 of ten low-band radiating elements 122 each and two linear arrays 130 of fifteen high-band radiating elements 132 each, it will be appreciated that the number of linear arrays 120, 130 and the number of radiating elements 122, 132 included in each of the linear array 120, 130 may be varied. It will also be appreciated that duplexing may be done in the radios instead of in the antenna 100, that the number(s) of radiating elements 122, 132 per sub-array may be varied, that different types of radiating elements may be used (including single polarization radiating elements) and that numerous other changes may be made to the base station antenna 100 without departing from the scope of the present invention.

Each phase shifter 150 shown in FIG. 2 may be implemented, for example, as a rotating wiper phase shifter. It will be appreciated, however, that other types of phase shifters may be used instead rotating wiper phase shifters such as, for example, trombone phase shifters, sliding dielectric phase shifters and the like.

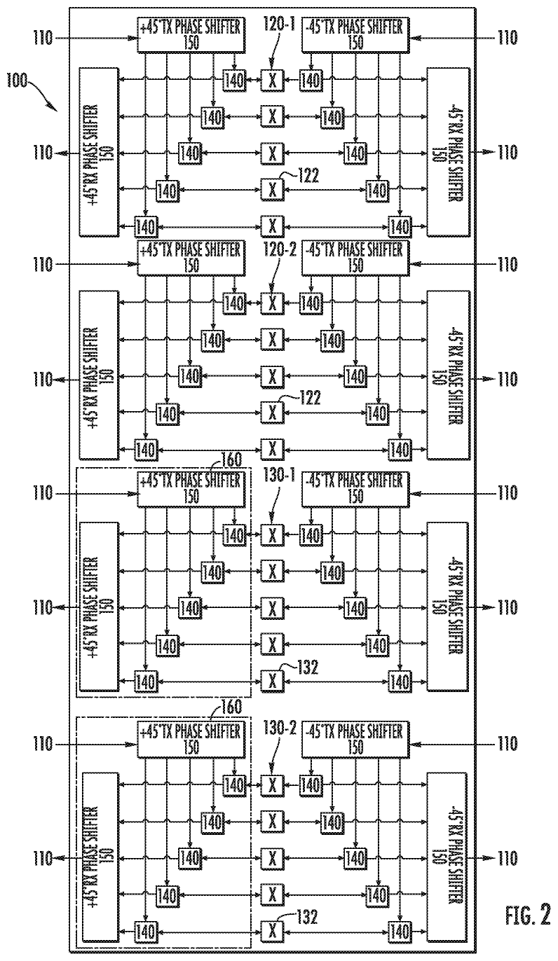

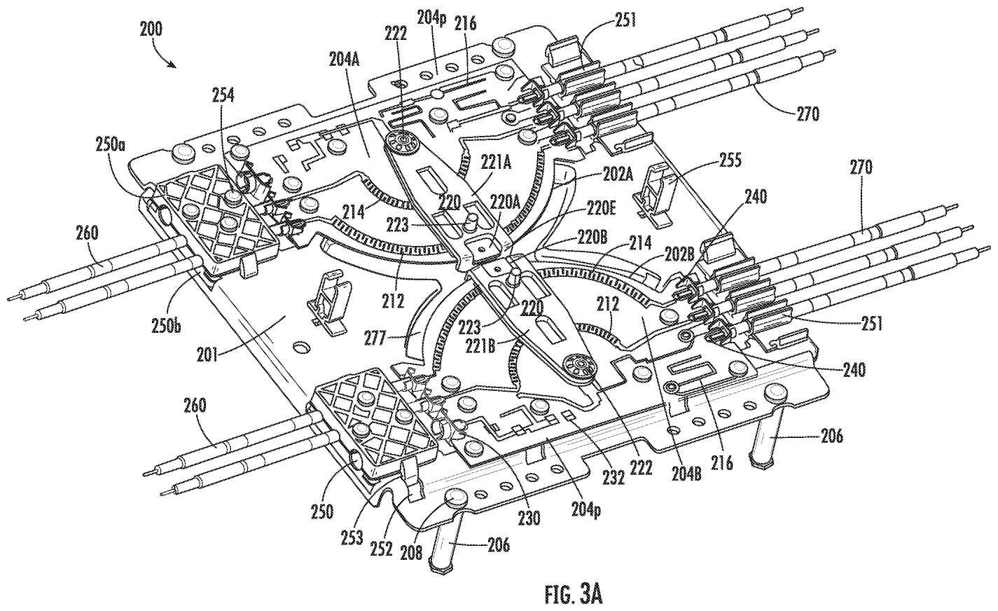

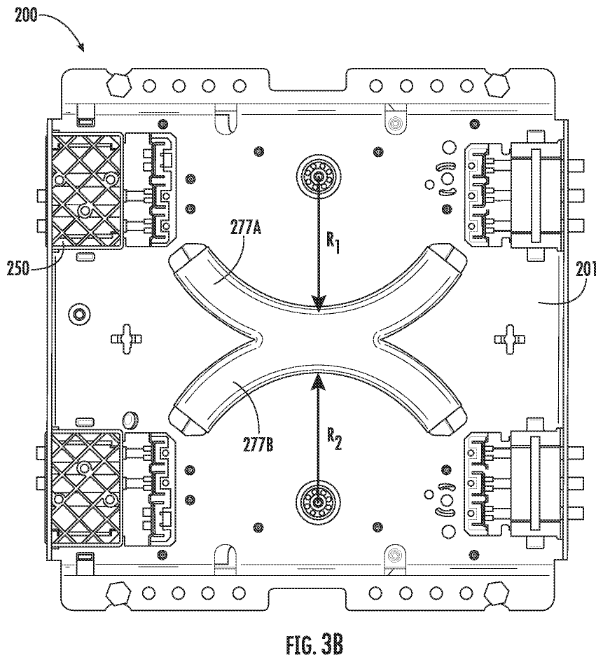

Referring now to FIG. 3A, a wiper phase shifter assembly 200 is illustrated that may be used to implement, for example, two of the phase shifters 150 of FIG. 2. The wiper phase shifter assembly 200 includes first and second phase shifters 202A, 202B.

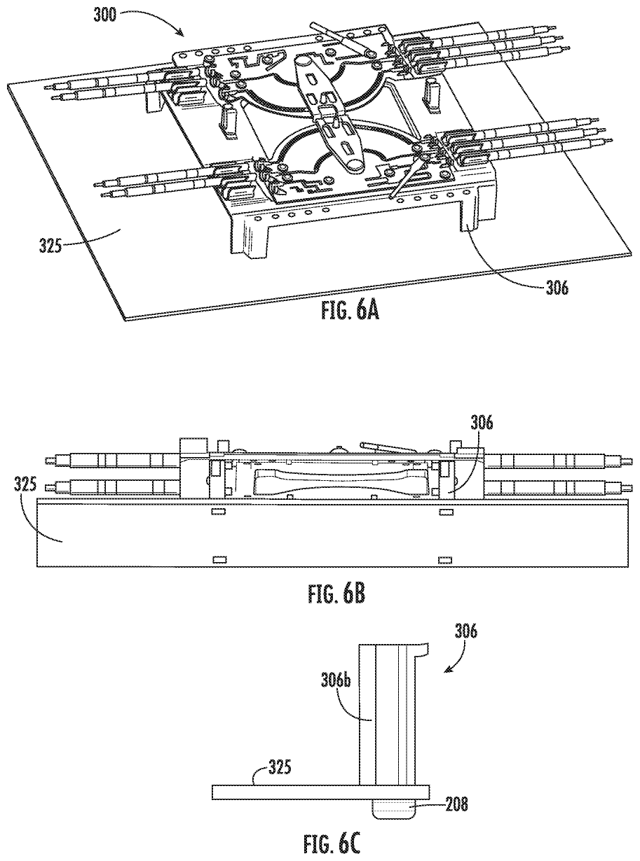

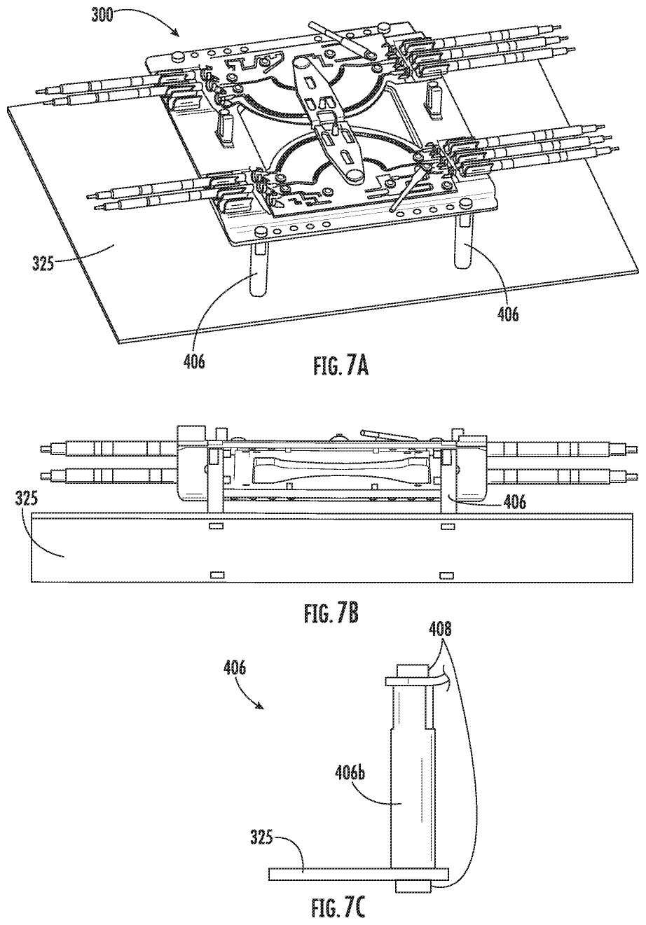

As shown in FIG. 3A, the phase shifter assembly 200 includes two (stationary) co-planar laterally spaced apart and adjacent main printed circuit boards 204A, 204B (the term “printed circuit board” can be interchangeably referred to as “PCB” herein) attached on a top side of a mounting base 201. The main PCBs 204A, 204B can each be attached mechanically or adhesively to the mounting base 201. A plurality of standoffs 206 are coupled to the mounting base 201 and connect the mounting base 201 (typically with metal screws 208) to an antenna reflector 325 (see, e.g., FIGS. 6A-6C and FIGS. 7A-7C). The soldering of the main PCBs 204A, 204B to the mounting base 201, and the mounting base 201 being coupled to the antenna reflector 325 by the standoffs 206, together provides an electrical ground for the phase shifter assembly 200. Typically, the mounting base 201 and standoffs 206 comprise aluminum, stainless steel, other metals or metal alloys. However, as discussed above, the metal-to-metal contact between the mounting base 201 and the standoffs 206 (and antenna reflector 325) can be a source of unwanted PIM within the base station antenna 100.

The two main PCBs 204A, 204B have a top side with a plurality of transmission lines 212, 214, 216. The phase shifter assembly 200 also includes two rotatable wipers 220, each comprising a first and a second rotatable wiper printed circuit boards 220A, 220B that are rotatably coupled to their respective main printed circuit board 204A, 204B. The wipers 220 can be pivotally mounted on their respective main printed circuit boards 204A, 204B at a pivot joint provided by a pivot pin 222 so that both wiper printed circuit boards 220A, 220B rotate in a desired direction relative to the main PCBs 204A, 204B. As shown, in some embodiments, each main PCB 204A, 204B may have a perimeter 210p which can include one arcuate side and three straight linear sides. The outer end of each wiper 220e can extend outside of and about the arcuate side.

Still referring to FIG. 3A, the wipers 220 can have a body with a closed outer end 220e that hold each respective first and second wiper printed circuit boards 220A, 220B. The wipers 220 can have an attachment link 223 that can couple to a bracket (not shown) that connects to a drive shaft (not shown) of a mechanical linkage allowing for phase shift adjustment. As shown, the protruding attachment link 223 is orthogonal to the wiper arms 221A, 221B and also extends outward from each of the arms 221A, 221B. However, the attachment link 223, where used, can have a different attachment configuration.

The position of each rotatable wiper printed circuit board 220A, 220B relative to their respective main printed circuit board 204A, 204B is controlled by the position of a drive shaft (not shown), the end of which may constitute one end of a mechanical linkage. The other end of the mechanical linkage (not shown) may be coupled to an output member of a RET actuator.

The third transmission line trace 216 on each of the main printed circuit boards 204A, 204B connects an input pad 230 to an output pad 240 that is not subjected to an adjustable phase shift. One or more input traces 232 also lead from the input pad 230 near an edge of the main printed circuit boards 204A, 204B to a respective wiper printed circuit board 220A, 220B adjacent the pivot pin 222. RF signals on a respective input trace 232 are coupled to a transmission line trace (not shown) on a corresponding wiper printed circuit board 220A, 220B, typically via a capacitive connection. The transmission line trace on the respective wiper printed circuit board 220A, 220B may split into a plurality of (i.e., two) secondary transmission line traces (not shown). The RF signals can be capacitively coupled from the secondary transmission line traces on the wiper printed circuit board 220A, 220B to the transmission line traces 212, 214 on the main printed circuit boards 204A, 204B. Each end of each transmission line trace 212, 214 may be coupled to a respective output pad 240. For example, each transmission line trace 212, 214 may be coupled to two output pads 240 (i.e., one on the left side of a main PCB 220A, 220B and one on the right side of a main PCB 220A, 220B).

A coaxial cable 260 or other RF transmission line component may be connected to input pad 230. A respective coaxial cable 270 or other RF transmission line component may be connected to each respective output pad 240. As the wiper printed circuit boards 220A, 220B move, an electrical path length from the input pad 230 to each corresponding output pad 240 changes.

For example, as each wiper printed circuit board 220A, 220B moves to the left it shortens the electrical length of the path from a corresponding input pad 230 to a corresponding output pad 240 connected to the left side of transmission line trace 212 (which connects to a first sub-array of radiating elements), while the electrical length from the input pad 230 to the output pad 240 connected to the right side of transmission line trace 212 (which connects to a second sub-array of radiating elements) increases by a corresponding amount. These changes in path lengths result in phase shifts to the signals received at the output pads 240 connected to transmission line trace 212 relative to, for example, the output pad 240 connected to transmission line trace 216.

Still referring to FIG. 3A, one or more connector block assemblies 250 can be used to provide the interface connection of the coaxial cables 260, 270 to the main PCBs 204A, 204B. Each connector block assembly 250 can be configured to hold a plurality of cables 260, 270 to route and support respective coaxial cables 260, 270 to the main PCBs 204A, 204B. The cable connector block assembly 250 may help restrict undesired movement of the cables 260, 270, and may strengthen electrical connections with the cables 260, 270, thereby improving performance of the associated base station antenna. Typically, the connector block assembly 250 comprises a top block 250a and bottom block 250b formed from plastic with at least one stainless steel screw for securing the top and bottom blocks 250a, 250b together. The bottom block 250b may be secured to a slot 252 in the mounting base 201 via a self-locking feature 253. Cable block assemblies 250 are primarily used on the input cable side 260 where the diameter of input cable 206 is larger than the diameter of the output cable 270 (e.g., phase cable).

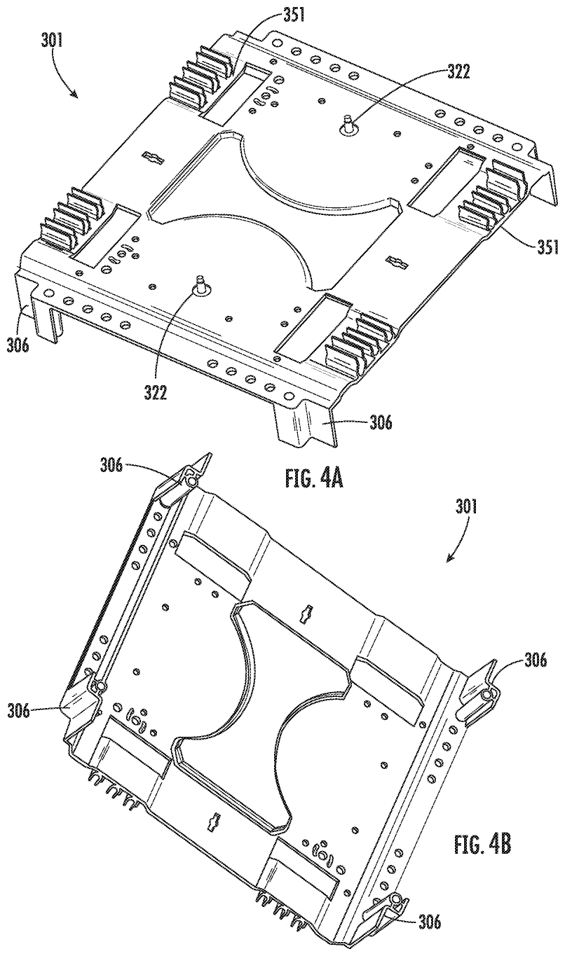

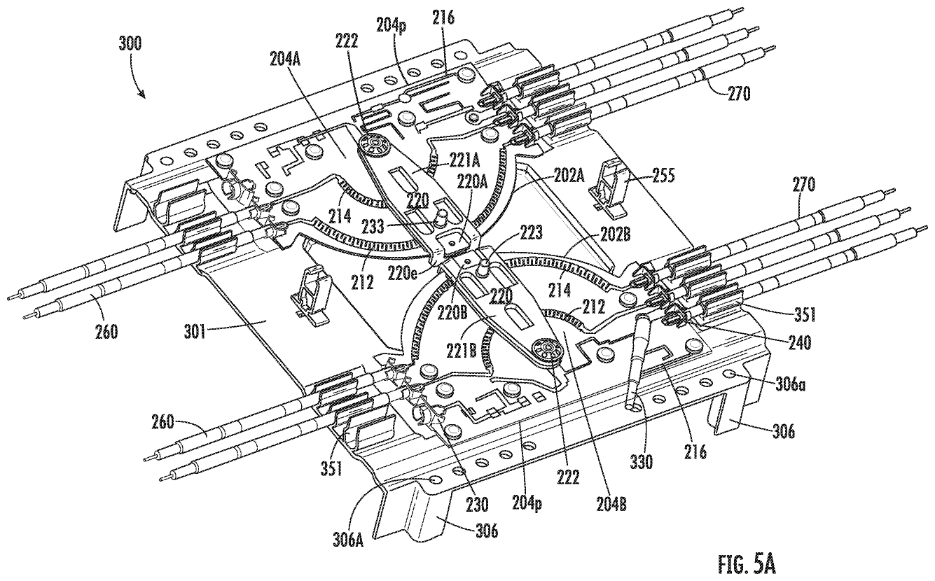

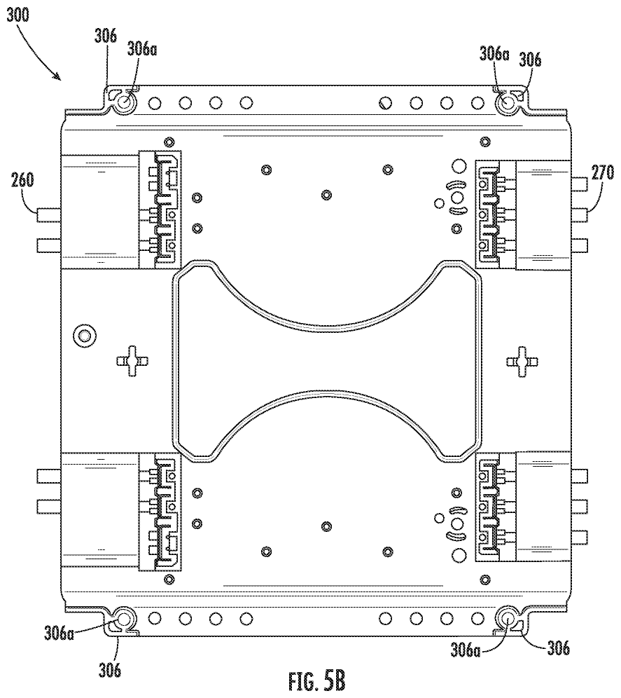

Cable retention clips 251 can also be used to provide the interface connection of the coaxial cables 260, 270 to the main PCBs 204A, 204B. Each clip 251 can define a longitudinally extending channel or recess that is sized and configured to receive and retain a respective RF cable 260 or 270 (see also, e.g., FIGS. 4A and 5A). The connector block assemblies 250 and/or cable retention clips 251 can hold the cables 260 or 270 in place during a soldering process and provide strain relief when a tower supporting a base station antenna that is subject to wind or other vibrations. Typically, the cable retention clips 251 may be formed from plastic and may be secured to the mounting base 201 via a self-locking snap feature (not shown).

The connector block assembly 250 and/or cable retention clips 251 may be configured to receive more or fewer of the cables 260, 270 than shown in FIGS. 3A, 5A, and 8F. For example, the connector block assembly 250 and cable retention clips 251 may be configured to receive one, two, four, five, six, seven, eight, or more of the cables 260, 270. For additional details of example connector block assemblies, see co-pending U.S. patent application Ser. No. 16/052,844, the contents of which are hereby incorporated by reference as if recited in full herein.

The mounting base 201 may comprise two arcuate slots 277 that allow the wipers 220A, 220B to rotate relative to the pivot joint 222. The slots 277 can reside adjacent the arcuate segment of the first transmission lines 212, closer to an outer edge of the perimeter 210p of the main PCBs 204A, 204B than the first transmission lines 212. As shown in FIG. 3B, the first and second arcuate slots 277 reside at a medial location of the mounting base 201 and the first slot 277A has a first radius of curvature R1 and the second slot 277B has a second radius of curvature R2. R1 can be equal to R2 but oriented to provide opposing rather than concentric arc segments.

Two rod supports 255 may be attached to the mounting base 201. The rod supports 255 provide support to square rods or a knob tilt mechanism (not shown) of a mechanical linkage that typically extends in a longitudinal direction of the base station antenna 100.

According to embodiments of the present invention, some of the components described above with respect to the phase shifter assembly 200 may be combined into a single non-metallic component. For example, as shown in FIGS. 4A-4B, according to some embodiments, the cable clips 351, pivot pins 322, and/or standoffs 306 may be integrated into the mounting base 301 to form a monolithic structure. In some embodiments, the cable block assemblies 250 are incorporated into the mounting base 301 (e.g., as cable clips 351). Additional components like push rivets 205 of the phase shifter assembly 200 may also be integrated into the mounting base 301.

In some embodiments, the monolithic mounting base 301 may be formed of a polymeric material. For example, in some embodiments, the monolithic mounting base 301 may be nylon, acetal, ABS, polycarbonate or polypropylene. The monolithic mounting base 301 may be formed by manufacturing techniques known in the art, such as, for example, plastic injection molding.

Referring now to FIGS. 5A-5B, a phase shifter assembly 300 adapted for reducing PIM within a base station antenna 100 is illustrated. The phase shifter assembly 300 is similar to the phase shifter assembly 200 described above expect that mounting base 201 is replaced with the monolithic mounting base 301 and the cable clips 351, pivot pins 322, and standoffs 306 integrated therein. In some embodiments, the phase shifter assembly 300 no longer has cable block assemblies 250. Rather, the cable block assemblies 250 are replaced with cable clips 351 which are integrated into the mounting base 301 of the phase shifter assembly 300. Replacing the metallic mounting base 201 (and metallic standoffs 206) with the integrated non-metallic mounting base 301 reduces the metal-to-metal contacts in the phase shifter assembly and with the antenna reflector 325 which can help to reduce PIM within the base station antenna 100.

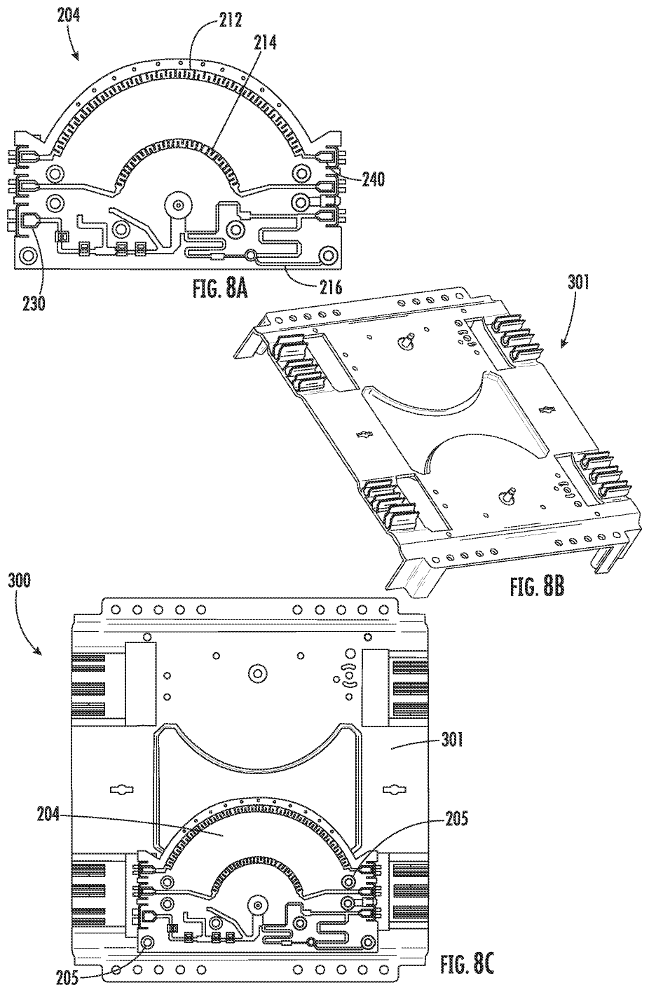

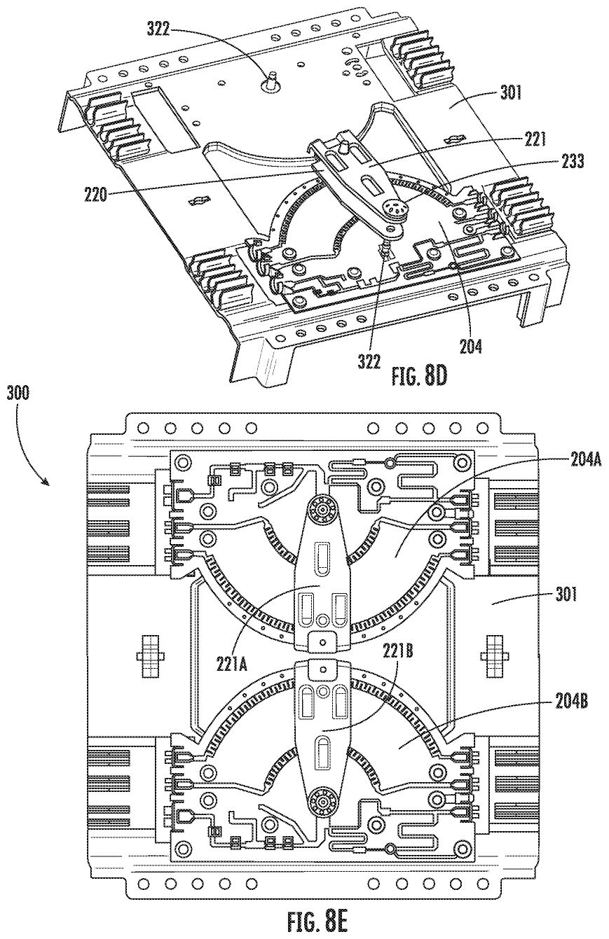

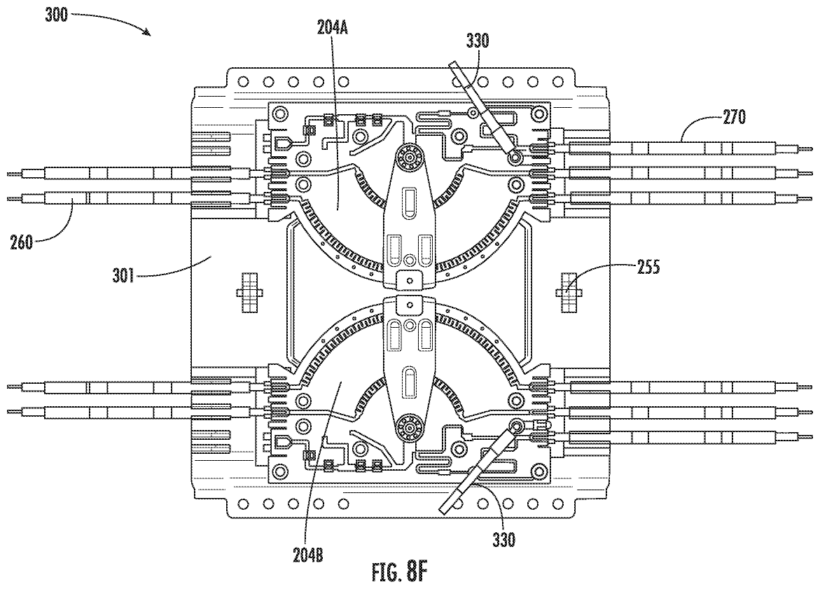

As shown in FIG. 5A, in some embodiments, the phase shifter assembly 300 may include a ground cable 330 connected to each main printed circuit board 204A, 204B (see also, e.g., FIG. 8F). As discussed above, the typical metallic standoffs 206 provided an electrical ground for the phase shifter assembly 200. However, by integrating non-metallic standoffs 306 into a non-metallic monolithic mounting base 301, the standoffs 306 no longer provide an electrical ground for the phase shifter assembly 300. Connecting ground cables 330 between the antenna reflector 325 (or another ground reference) and the main printed circuit boards 204A, 204B provides an electrical ground for the phase shifter assembly 300.

Referring to FIGS. 6A-6C, in some embodiments, the monolithic mounting base 301 is mounted to the antenna reflector 325, using M4 self-tapping screws with plastic and metal washers 208. The standoffs 306 may comprise an integrated boss 306b with a hole 306a sized to receive an M4 screw 208. As shown in FIG. 6C, in some embodiments, M4 self-tapping screws 208 may be inserted through the hole 306a of each integrated boss 306b and secured to the antenna reflector 325 with washers. In some embodiments, plastic washers may be used with the screws 208 to further mitigate possible PIM caused by the metal-to-metal contact between the metal screws 208 and the antenna reflector 325.

Referring to now FIGS. 7A-7C, alternative non-metallic standoffs 406 are illustrated. As shown in FIG. 7C, in some embodiments, non-metallic standoffs 406 may comprise plastic support posts 406b. In some embodiments, combination of plastic support posts 406b and nylon screws 408 may be used to mount the mounting base 301 to the antenna reflector 325. This method has the flexibility in mounting by enabling usage of multiple holes on the mounting base for mounting. Using non-metallic standoffs 406 and nylon screw 408 may further mitigate possible PIM within the base station antenna 100.

Exemplary steps for assembling a phase shifter assembly 300 adapted for mitigating passive intermodulation (PIM) within a base station antenna 100 is provided and illustrated in FIGS. 8A-8F. FIG. 8A shows the phase shifter main printed circuit board 204 with connectors attached to the main printed circuit board 204. FIG. 8B shows a monolithic mounting base 301 according to embodiments of the present invention. The monolithic mounting base 301 in FIG. 8B may be formed, for example, by injection molding. FIG. 8C illustrates one of the phase shifter main printed circuit boards 204 attached to the mounting base 301, for example, using push rivets 205. FIG. 8D illustrates a wiper printed circuit board 220 and wiper support arm 221 being secured to the main printed circuit board 204 and the pivot pin 322 of the mounting base 301 using a copper locking button 233. FIG. 8E shows the same process repeated for the other phase shifter printed circuit board assembly. FIG. 8F illustrates cables 260, 270 fixed and positioned within the cable clips 351 of the monolithic mounting base 301 and ground cables 330 connected to each main printed circuit board 204A, 204B. The assembled phase shifter assembly 300 may then be mounted with the cables 260, 270 onto the antenna reflector 325 of the base station antenna 100, for example, using M4 self-tapping screws. Assembly process and sequence explained above may be changed or altered based on the level of automation, specific production plant procedure, and antenna assembly sequence.

Embodiments of the present invention provide numerous advantages over current base station antennas and phase shifter assemblies. For example, by reducing the number of components of the phase shifter assembly, the assembly process is simplified thereby reducing the assembly time. Reducing the number of components also helps to reduce material and manufacturing costs. Finally, reducing or eliminating metal-to-metal contact within the base station antenna may help with improved PIM performance.

As noted above, a RET actuator is used to drive the moveable element of a phase shifter 150 and/or phase shifter assembly 200, 300. See, e.g., U.S. Provisional Application Ser. No. 62/696,996, the contents of which are hereby incorporated by reference as if recited in full herein for example components an RET actuator that may be used in the base station antennas according to embodiments of the present invention. The RET actuator can be a multi-RET actuator that includes multiple output members that can drive multiple respective mechanical linkages.

It will be appreciated that the above embodiments are intended as examples only, and that a wide variety of different embodiments fall within the scope of the present invention. It will also be appreciated that any of the above embodiments or features of different embodiments may be combined.

The present invention has been described above with reference to the accompanying drawings. The invention is not limited to the illustrated embodiments; rather, these embodiments are intended to fully and completely disclose the invention to those skilled in this art. In the drawings, like numbers refer to like elements throughout. Thicknesses and dimensions of some components may be exaggerated for clarity.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Herein, the terms “attached”, “connected”, “interconnected”, “contacting”, “mounted” and the like can mean either direct or indirect attachment or contact between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

1. A phase shifter assembly, comprising:
a mounting base formed of a non-metallic material;
a first main printed circuit board and a second main printed circuit board attached to the mounting base, wherein each of the main printed circuit boards comprises a plurality of radio frequency (“RF”) transmission paths;
a first wiper arm rotatably coupled to the first main printed circuit board and electrically coupled to at least some of the plurality of RF transmission paths; and
a second wiper arm rotatably coupled to the second main printed circuit board and electrically coupled to at least some of the plurality of RF transmission paths.

2. The phase shifter assembly of claim 1, further comprising a plurality of cable clips, a pair of pivot pins, and a plurality of mounting standoffs, wherein the cable clips, the pivot pins, and the mounting standoffs are each formed of a non-metallic material.

3. The phase shifter assembly of claim 2, wherein the plurality of cable clips, the pair of pivot pins, the plurality of mounting standoffs, and mounting base form a monolithic structure.

4. The phase shifter assembly of claim 1, wherein the non-metallic material forming the mounting base comprises a polymeric material.

5. The phase shifter assembly of claim 4, wherein the polymeric material. comprises nylon, acetal, ABS, polycarbonate or polypropylene.

6. The phase shifter assembly of claim 1, wherein the mounting base is formed by injection molding.

7. The phase shifter assembly of claim 1, further comprising a ground cable electrically connected to a ground layer of the first and second main printed circuit boards.

8. The phase shifter assembly of claim 1, further comprising a plurality of mounting standoffs, wherein each mounting standoff comprises a support post formed of a non-metallic material.

9. A phase shifter assembly, comprising:
a mounting base;
a first main printed circuit board and a second main printed circuit board attached to the mounting base, wherein each of the main printed circuit boards comprises a plurality of radio frequency (“RF”) transmission paths;
a first wiper arm rotatably coupled to the first main printed circuit board and electrically coupled to at least some of the plurality of RF transmission paths;
a second wiper arm rotatably coupled to the second main printed circuit board and electrically coupled to at least some of the plurality of RF transmission paths;
a plurality of cable clips;
a pair of pivot pins, wherein the first and second wiper arms are each secured a respective pivot pin; and
a plurality of mounting standoffs,
wherein the cable clips, the pivot pins, the mounting standoffs, and the mounting base form a monolithic structure comprising a polymeric material.

10. The phase shifter assembly of claim 9, wherein the polymeric material comprises nylon, acetal, ABS, polycarbonate or polypropylene.

11. The phase shifter assembly of claim 9, wherein the monolithic structure of each phase shifter assembly is formed by injection molding.

12. The phase shifter assembly of claim 9, further comprising a ground cable electrically connected to a ground layer of the first and second main printed circuit boards.

13. A base station antenna, comprising:
a plurality of phase shifter assemblies, each phase shifter assembly comprising:
a mounting base formed of a non-metallic material;
a first main printed circuit board and a second main printed circuit board attached to the mounting base, wherein each main printed circuit board comprises a plurality of radio frequency (“RF”) transmission paths;
a first wiper arm rotatably coupled to the first main printed circuit board and electrically coupled to at least some of the plurality of RF transmission paths; and
a second wiper arm rotatably coupled to the second main printed circuit board and electrically coupled to at least some of the plurality of RF transmission paths.

14. The base station antenna of claim 13, wherein each phase shifter assembly further comprises a plurality of cable clips, the pivot pins, and a plurality of mounting standoffs formed of a non-metallic material and attached to the mounting base.

15. The base station antenna of claim 14, wherein the plurality of cable clips, the pivot pins, the plurality of mounting standoffs, and the mounting base form a monolithic structure.

16. The base station antenna of claim 13, wherein each phase shifter assembly further comprises a plurality of mounting standoffs, each mounting standoff comprising a support post formed of a non-metallic material.

17. The base station antenna of claim 13, wherein the non-metallic material forming the mounting base of each phase shifter assembly comprises a polymeric material.

18. The base station antenna of claim 17, wherein the polymeric material comprises nylon, acetal, ABS, polycarbonate or polypropylene.

19. The base station antenna of claim 13, wherein the mounting base of each phase shifter assembly is formed by injection molding.
